(19) United States
(12) Patent Application Publication
(10) Pub. No.: US 2013/0311265 A1
(43) Pub. Date: Nov. 21, 2013

(54) ELECTRONIC PAYMENT SYSTEM AND METHOD

(71) Applicant: Caerwyn Geraint Prothero, St. Neots (GB)

(72) Inventor: Caerwyn Geraint Prothero, St. Neots (GB)

(73) Assignee: iCheque Network Ltd., Windsor (GB)

(21) Appl. No.: 13/867,721

(22) Filed: Apr. 22, 2013

(30) Foreign Application Priority Data
Apr. 23, 2012 (GB) 1207108.0

(51) Int. Cl. G06Q 20/38

(52) U.S. Cl. CPC G06Q 20/387
USPC 705/14.26

(57) ABSTRACT

An electronic payment system is described that includes a payer device capable of performing an electronic payment process in which an electronic payment is executed, the payer device including a positioning unit that is capable of determining the current location of the payer device, a payee device capable of receiving the electronic payment; and a payment verification unit that is capable of performing a location-based verification check. The payer device transmits its current location to the payment verification unit during the electronic payment process and the payment verification unit accepts or rejects the electronic payment based on the current location of the payer device. A corresponding method is also described.

The invention relates to an electronic payment system and method, and particularly, but not exclusively, to an electronic voucher system and method.

### BACKGROUND

Various voucher systems are known and used extensively worldwide. A voucher is a bond which has a monetary value and which may be used as payment for specific goods or services only. For example, vouchers may be issued by a retailer which can only be redeemed with that retailer (or possibly with a related retailer, such as a subsidiary or group company). Vouchers are typically transferable so that they can be purchased by one person and redeemed by a different person. Accordingly, vouchers are often given as gifts.

Historically, voucher systems have been implemented in a physical form, where the issued vouchers are paper-based (such as a gift certificate) or card-based (having, for example, a magnetic strip or barcode).

More recently, voucher systems have also been implemented in an electronic form. Such systems issue electronic vouchers (or e-vouchers) which are virtual (i.e. they only exist in the form of data) and which can be used in online transactions with retailers and other merchants. Electronic vouchers generally take the form of a unique numeric (or alphanumeric) code. The codes used for electronic vouchers are designed to provide security. In other words, the codes are designed to prevent someone who has purchased an electronic voucher from being able to deduce another valid code.

The codes of electronic vouchers may be easily sent to friends and family as gifts, for example, via email. This provides a major advantage over conventional physical systems.

Electronic vouchers also enable users to pay online for goods and services without having to reveal their bank or card details to the merchant. The use of electronic vouchers may therefore reduce card fraud. Further, using electronic vouchers prevents the user's online transactions from appearing on their bank statement. This may be beneficial since certain transactions (such as deposits with gambling companies) may prejudice credit checks, and mortgage and other financial product applications.

Electronic voucher systems may also be beneficial for merchants since they may remove the need for merchants to provide costly and complex security systems for protecting customers from fraud.

An example of an electronic voucher system is the Applicant's iCheque electronic voucher. An iCheque is a single-use electronic voucher that enables users to pay online without having to reveal their bank or card details to the retailer. A customer purchases an iCheque from any Approved Reseller for the exact value needed, and uses it to pay at a range of Retail Partners.

It is desirable to improve the security of the conventional electronic voucher systems for both the issuer and user. It is also desirable to improve the usability of the system, particularly through improving the user experience and efficiency when redeeming electronic vouchers.

### STATEMENTS OF INVENTION

According to an aspect of the invention, there is provided an electronic payment system. The system comprises: a payer device configured to perform an electronic payment process in which an electronic payment is executed. The payer device comprises positioning means which is configured to determine the current location of the payer device. The system further comprises a payee device configured to receive said electronic payment and a payment verification means which is configured to perform a location-based verification check. The payer device transmits its current location to the payment verification means during the electronic payment process and the payment verification means accepts or rejects the electronic payment based on the current location of the payer device.

The electronic payment may be made to a payment account associated with the payee device. The payee device may be a device of an electronic voucher issuer. In this case, the electronic payment may be made by a user to the electronic voucher issuer. The electronic payment may be a card payment or other suitable payment method for purchasing an electronic voucher from the electronic voucher issuer.

Alternatively, the payee device may be a device of a merchant. For example, the merchant may be a retailer providing goods or a provider of services, such as a gambling company.

The electronic payment may be an electronic voucher. The payer may be a customer of the merchant and the electronic payment (for example, an electronic voucher) may be used as payment for goods or services.

The positioning means of the payer device may comprise a global positioning system or other similar positioning system.

The payment verification means may have access to a storage means in which there is stored a definition of one or more locations in which the electronic payment will be accepted by the location-based verification check. The storage means may form part of the payment verification means.

Alternatively, or in addition, the payment verification means may have access to a storage means in which there is stored a definition of one or more locations in which the electronic payment will be rejected by the location-based verification check. The storage means may form part of the payment verification means.

For example, the one or more locations may be defined in a storage means of the payee device, the payer device or a third party device (such an electronic payment issuer, when the payment is being made to a merchant).

The storage means may be comprise volatile and/or non-volatile computer memory.

The one or more locations may comprise one or more countries or states. This may allow the payment verification means to determine an appropriate jurisdiction for the payer and to apply laws or rules applicable to that jurisdiction to determine whether payment can be accepted. This may also allow the payment verification means to determine whether the payee is able to supply goods or services to the payer in that current location. For example, the payee may only be licensed to supply goods or services to the payer in certain countries or states. Accordingly, it may be illegal or prohibited for the payee to supply customers in other jurisdictions.

The one or more locations may comprise a billing address of the payer. For example, the location-based verification check may utilise the Address Verification System (AVS).

Where the payer is located at the billing address the payment verification means may accept the payment. In contrast, where the payer is located away from their billing address, the payment verification means may reject the payment since this may indicate fraudulent use of the payer's account. Accordingly, the location-based verification check may improve the security of the electronic payment system.

The one or more locations may comprise a registered location of the payer or payer device. The registered location may have been provided during a registration process by using the positioning means of the payer device. Again, the payment verification means may accept the payment when the payer is currently located at the registered location and may reject the payment when the payer is located away from the registered location. Accordingly, this may prevent fraudulent use of the payer's account, thus improving the security of the electronic payment system.

The positioning means may not be able to determine the exact location of the payer. For example, the positioning means may provide an estimated location with an associated precision and/or accuracy value. This produces a circular area with its centre at the estimated location and having a radius determined by the precision and/or accuracy of the measurement.

The (instantaneous or current) precision and/or accuracy of the positioning means may be used by the payment verification means in determining whether the current location falls within the one or more locations stored in the storage means.

The payment verification means may determine a probability of the current location falling within the one or more locations stored in the storage means and may output a judgment based on whether the probability is greater than or less than a predetermined threshold value.

For example, the probability may be based on the proportion of the enclosed area (determined by the estimated location and the precision and/or accuracy of the measurement) which falls within the or each stored location. If the proportion falling within a stored location exceeds a threshold value (for example, 70%), it may be assumed that the current location falls within that location. The payment verification means may accept or reject the payment accordingly.

The payment verification means may perform one or more data verification checks based on the current location of the payer device, and may accept or reject the electronic payment based on the outcome of the data verification checks.

For example, the data verification checks may comprise an age verification check. The payment verification means may determine the jurisdiction in which the payer is located and apply an age verification based on the laws or regulations for that jurisdiction. The age verification check may be based on the goods or services for which the payment is being made.

For example, where the payer is making a payment to a gambling company and the payer is found to be located in the US state of Nevada, the payment verification means may verify whether the payer is over the age of 21, which is the legal gambling age in that state. This may also be used where the payer is purchasing goods which have age restrictions in certain jurisdictions, such as cigarettes or alcohol.

The payer device, the payee device or a third party device may comprise the payment verification means.

According to another aspect of the invention, there is provided an electronic payment system comprising: a payer device configured to perform an electronic payment process in which an electronic payment is executed. The payer device comprises positioning means which is configured to determine the current location of the payer device. The system further comprises a payee device configured to receive said electronic payment and having a storage means. The payer device transmits its current location to the payee device during a registration process and the payee device stores the payer device's current location as a registered location in the storage means.

The registered location stored in the storage means may be subsequently used in a location-based verification check in which the positioning means of the payer device is used to verify that its current location is the registered location.

Accordingly, this may prevent fraudulent use of the payer's account, thus improving the security of the electronic payment system.

According to another aspect of the invention, there is provided an electronic payment method comprising: transmitting an electronic payment using a payer device, the payer device having positioning means which is configured to determine the current location of the payer device, and receiving the electronic payment using a payee device. The method further comprises determining the current location of the payer device using the positioning means and transmitting the current location of the payer device to a payment verification means, and performing at the payment verification means a location-based verification check in which the payee device accepts or rejects the electronic payment based on the current location of the payer device.

The electronic payment may be made to a payment account associated with the payee device. The payee device may be a device of an electronic voucher issuer. In this case, the electronic payment may be made by a user to the electronic voucher issuer. The electronic payment may be a card payment or other suitable payment method for purchasing an electronic voucher from the electronic voucher issuer.

Alternatively, the payee device may be a device of a merchant. For example, the merchant may be a retailer providing goods or a provider of services, such as a gambling company.

The electronic payment may be an electronic voucher. The payer may be a customer of the merchant and the electronic payment (for example, an electronic voucher) may be used as payment for goods or services.

The location-based verification check may comprise determining whether the current location corresponds to one or more defined locations in which the electronic payment will be accepted.

The location-based verification check may comprise determining whether the current location corresponds to one or more defined locations in which the electronic payment will be rejected.

The one or more locations may comprise one or more countries or states. This may allow the payment verification means to determine an appropriate jurisdiction for the payer and to apply laws or rules which are applicable to that jurisdiction to determine whether payment can be accepted. This may also allow the payment verification means to determine whether the payee is able to supply goods or services to the payer in that current location. For example, the payee may only be licensed to supply goods or services to the payer in certain countries or states. Accordingly, it may be illegal or prohibited for the payee to supply customers in other jurisdictions.

The one or more locations may comprise a billing address of the payer. For example, the location-based verification check may utilise the Address Verification System (AVS).

Where the payer is located at the billing address the location-based verification check may accept the payment. In contrast, where the payer is located away from their billing address the location-based verification check may reject the payment since this may indicate fraudulent use of the payer's account. Accordingly, the location-based verification check may improve the security of the electronic payment system.

The one or more locations may comprise a registered location of the payer or payer device. The registered location may have been provided to the payee device during a registration process by using the positioning means of the payer device. Again, the payment verification means may accept the payment when the payer is currently located at the registered location and may reject the payment when the payer is located away from the registered location. Accordingly, this may prevent fraudulent use of the payer's account, thus improving the security of the electronic payment system.

The positioning means may not be able to determine the exact location of the payer. For example, the positioning means may provide an estimated location with an associated precision and/or accuracy value. This produces a circular area with its centre at the estimated location and having a radius determined by the precision and/or accuracy of the measurement.

The (instantaneous or current) precision and/or accuracy of the positioning means may be used by the payment verification means in determining whether the current location falls within the one or more locations stored in the storage means.

The location-based verification check may further comprise determining a probability of the current location falling within the one or more locations stored by the payee device; comparing the probability with a predetermined threshold value; and outputting a judgment based on whether the probability is greater than or less than the predetermined threshold value.

For example, the probability may be based on the proportion of the enclosed area (determined by the estimated location and the precision and/or accuracy of the measurement) which falls within the or each stored location. If the proportion falling within a stored location exceeds a threshold value (for example, 70%), it may be assumed that the current location falls within that location. The payment verification means may accept or reject the payment accordingly.

The location-based verification check may comprise performing one or more data verification checks based on the current location of the payer device, and accepting or rejecting the electronic payment based on the outcome of the data verification checks.

For example, the information verification checks may comprise an age verification check. The payment verification means may determine the jurisdiction in which the payer is located and apply an age verification based on the laws or regulations for that jurisdiction. The age verification may be based on the goods or services for which the payment is being made.

For example, where the payer is making a payment to a gambling company and the payer is found to be located in the US State of Nevada, the payment verification means may verify whether the payer is over the age of 21, which is the legal gambling age in that state. This may also be used where the payer is purchasing goods which have age restrictions in certain jurisdictions, such as cigarettes or alcohol.

The electronic payment method may be executed by a computer program. In particular, the computer program may be loaded onto the payer's smartphone as an application or app.

According to another aspect of the invention, there is provided an electronic payment method comprising: a payer making an electronic payment with a merchant, the electronic payment being issued by an electronic payment issuer. The merchant then performs a step of requesting information regarding the payer from the issuer. Subsequently, the issuer performs a step of obtaining the requested information from a database containing information provided by the payer during a payer registration process with the issuer and transmitting the requested information to the merchant.

The electronic payment may be an electronic voucher.

The requested information may comprise personal details of the payer. The personal details of the payer may comprise information required to enable the merchant to supply goods or services to the payer. For example, the personal details may include an address of the payer to which the purchased goods are to be sent.

The requested information may comprise information obtained during a customer verification check performed by the issuer during the payer registration process.

Such information may form a customer due diligence check, such as a “Know Your Customer” (KYC) check. These customer checks may be required under certain regulations.

Alternatively, or in addition, the requested information may be a result of a customer verification check performed by the issuer during the payer registration process. This may avoid the issuer having to send the acquired information to the merchant where the merchant recognizes (trusts) the result of the issuer's customer verification check.

The electronic payment may improve the efficiency and user experience for the payer since the issuer provides the required information to the merchant instead of the payer having to input or send such information to each and every merchant with which they perform transactions.

The method may further comprise confirming with the payer that they consent to the issuer transmitting the requested information to the merchant. Such a step may be required to satisfy data protection regulations. Here the issuer is only permitted to send the required information to the merchant once the payer has confirmed that the issuer may do so.

The requested information may be transmitted from the issuer to the merchant via a software-to-software interface. For example, the requested information may be transmitted via an Application Programming Interface or API. An API provides seamless integration of different pieces of software and performs functions which are not visible to the payer.

The request from the merchant to the issuer may also be transmitted from the merchant to the issuer via a software-to-software interface, such as an API.

By transmitting the requested information to the merchant from the issuer, it is possible to reduce the storage requirements of merchants. In other words, the payer information is held centrally and only sent to merchants when it is required. This also improves data security.

### BRIEF DESCRIPTION OF THE DRAWINGS

For a better understanding of the present disclosure, and to show more clearly how it may be carried into effect, reference will now be made, by way of example, to the accompanying drawings, in which:

FIG. 1 is a schematic representation of an electronic voucher system according to an embodiment of the invention;

FIG. 2 is a flowchart of an account registration process for registering with an electronic voucher issuer of the electronic voucher system;

FIG. 3 is a flowchart showing a process for purchasing an electronic voucher from the electronic voucher issuer;

FIG. 4 is a flowchart showing a process for redeeming an electronic voucher with a merchant of the electronic voucher system; and

FIG. 5 is a map illustrating a location probability function used in the electronic voucher system.

### DETAILED DESCRIPTION

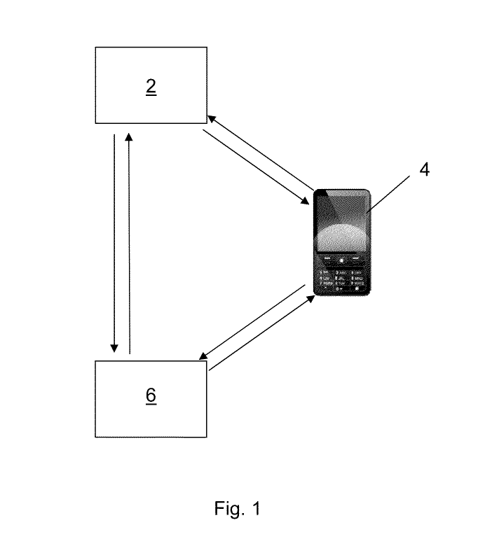

With reference to FIG. 1, an electronic voucher system according to an embodiment of the invention is shown. The electronic voucher system involves at least three parties: an electronic voucher issuer 2, a user 4 and a merchant 6. Of course, each electronic voucher issuer 2 may have a plurality of users 4, and the users 4 may perform transactions with a plurality of related or unrelated merchants 6.

The issuer 2 is responsible for issuing electronic vouchers to users 4 and for controlling the redemption of such vouchers with merchants 6. The function of the issuer 2 will be described in more detail below.

The electronic voucher system may also comprise one of more intermediaries which act as resellers. In this case, the issuer 2 does not directly supply electronic vouchers to the users 4, but instead supplies the resellers who, in turn, supply the users 4.

As shown by the arrows in FIG. 1, the issuer 2 is able to communicate (i.e. both transmitting and receiving) with the user 4 via the user's smartphone. The smartphone is configured to access the internet via either a 3G connection (or the like) or a Wi-Fi connection. Such connectivity also allows the user 4 to communicate with the issuer 2. In addition, the smartphone comprises a Global Positioning System (GPS) or other positioning system which provides a location of the smartphone and the user 4.

In turn, the user 4 is able to communicate with the merchant 6. The merchant 6 may be any party to which the user 4 wishes to make a payment using an electronic voucher and which accepts payment using an electronic voucher issued by the issuer 2. For example, the merchant 6 may be a retailer from which the user 4 wishes to purchase one or more items. Alternatively, the merchant 6 may be a service provider, such as a gambling company.

The issuer 2 and merchant 6 are also configured to perform two-way communication. Although FIG. 1 shows direct communication between the issuer 2 and merchant 6, they may in fact communicate via the user's smartphone, as will be described in more detail below.

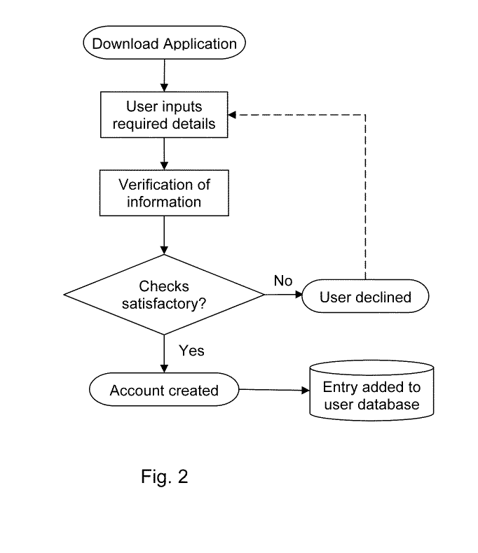

To allow the user 4 to purchase electronic vouchers from the issuer 2, the user 4 must register with the issuer 2. FIG. 2 shows a flowchart of a registration process which is performed between the user 4 and the issuer 2.

Initially, the user 4 downloads and installs a mobile application or app onto their smartphone. For example, the user 4 may purchase (although the application may be provided by the issuer 2 as a free download) the electronic voucher application from an application distribution platform, such as the Apple App Store or Google Play (previously the Android Market).

Once installed, the user 4 opens the electronic voucher application on their smartphone and sets up a user account with the issuer 2. Accordingly, the user 4 inputs required details into the electronic voucher application to register with the issuer 2. These details may include their full name, email address, date of birth, telephone number, passport number, national security number, etc. The user may also be required to select a username and password which are used to access their account and thus provides security in case they were to lose their smartphone. The user 4 may also be required to input their password when purchasing or redeeming an electronic voucher in order to provide another level of security.

As part of the registration process, the user 4 may also be required to provide details of one or more payment cards which they wish to associate with the account. Accordingly, they may be required to input details regarding the payment cards, such as the card number, start date, expiry date, name on card, card security code, etc. The user 4 may also designate a bank account to which payments may be made (for example, in the case of gambling winnings). However, such financial information may be provided at a later date (i.e. prior to first purchasing an electronic voucher) and not required as part of the initial registration process.

The registration process may also include other functions, such as setting up a payment limit which determines the total value of electronic vouchers which may be purchased over a particular time frame (such as a day, week or month).

Once the various information has been provided by the user 4, it is submitted to the issuer 2. At the same time, the user 4 must activate the application whilst physically located at the address provided during the registration process. During this activation, the GPS function of the user's smartphone determines the user's (i.e. the smartphone's) current position and transmits this information to the issuer 2. Alternatively, activation may be performed at a later date, for example, where the user 4 is not at their registered address during registration.

When activated, the issuer 2 sends a confirmation message containing a personal identification number (PIN) to the user 4. The PIN may be sent to the user 4 via an email or an SMS text message. The PIN is required in order to access the application for the first time after activation. The user 4 may be prompted to change the PIN when they first use the application. Alternatively, the PIN may only be required to first access the application and thereafter no longer needed.

The information is then verified by the issuer 2. As part of this verification check, the issuer 2 verifies that the information has been validly entered (i.e. in the correct format). The issuer 2 also carries out a number of checks to confirm that the user 4 is who they say they are. These checks may satisfy customer due diligence requirements, such as a “Know Your Customer” (KYC) check.

The verification checks may include confirming that the location of the user 4 provided during activation by the GPS function of their smartphone corresponds to their registered address. If the user 4 is not currently located at, or in close proximity, to their registered address, activation is not possible.

The issuer 2 may also perform searches within electronic databases, such as the electoral role, to confirm that the user lives at the address provided.

If electronic verification is not sufficiently robust, the issuer 2 may use traditional paper-based KYC checks. This may include the user 4 submitting a copy of a utility bill to the issuer 2 to confirm their address.

The issuer 2 may also confirm that the user 4 is in control of the identified payment card or bank account. This may be achieved by depositing small sums of money into the payment card or bank account. The user 4 will then be asked to verify the values of the deposits to confirm that they are in charge of the accounts registered.

Once the verification checks have been completed, the issuer 2 creates the user account and sets the account as being live. The user 4 is then able to fully access the functions of the application and to purchase electronic vouchers from the issuer 2.

On the other hand, if the verification checks are unsatisfactory, the issuer 2 may decline the user 4 and not create an account. As indicated by the dashed line in FIG. 2, the user 4 may be provided with an opportunity to provide additional or replacement information which can form the basis for repeat verification checks.

As described above, the issuer 2 may send the confirmation message after activation i.e. before the verification checks have been completed. In this case, the user 4 may only have limited access to the functions of the application and may not be allowed to purchase any electronic vouchers until the verification checks have been completed. Alternatively, the issuer 2 may allow the user 4 to purchase electronic vouchers having a total or individual value which is lower than a predetermined allowable value. This enables the user 4 to familiarise themselves with the application and also means that they can start using the service on impulse immediately, rather than after a few days. Such access may also be granted to users who have not yet submitted the required information to allow the issuer 2 to perform the verification checks.

When the user account is created, the issuer 2 stores details of the account and the information provided by the user 4 during the registration process in a user database. This includes the information provided for the completion of the customer due diligence checks and more general personal information of the user 4. This information may be retrieved at a later date and provided to the merchant 6, as will be described in more detail below.

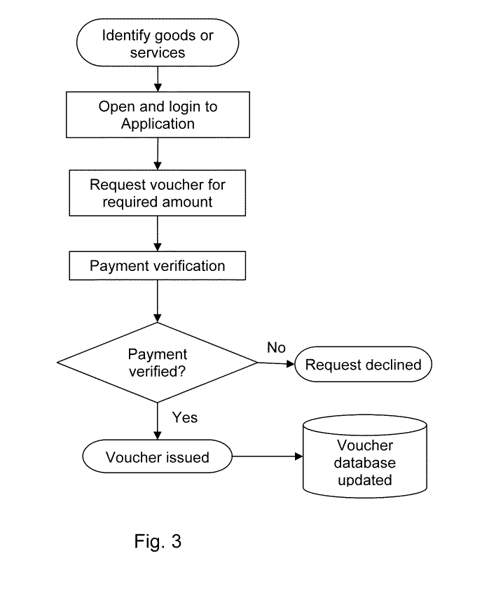

FIG. 3 shows a flowchart of a process for purchasing an electronic voucher from the issuer 2. In this respect, the user 4 is a payer and the user's smartphone functions as a payer device. Similarly, the issuer 2 is a payee and their computer systems form a payee device. Here an electronic payment is made using a card payment or other similar form of payment.

Initially, the user 4 identifies goods or services which they wish to purchase or acquire from the merchant 6. After identifying the total cost of the goods or services, the user opens the electronic voucher application on their smartphone and logs in to their account.

The user 4 requests an electronic voucher for the required amount from the issuer 2. The amount requested may be a value to two decimal places and for a selected currency from a list of permitted currencies set by the issuer 2.

To purchase the electronic voucher, the user 4 selects one of the payment cards entered during the registration process and stored in the user database of the issuer 2.

The user 4 then confirms the purchase of the electronic voucher. The request is transmitted by the electronic voucher application to the issuer 2 where a payment verification is made. In particular, a payment server of the issuer 2 may initiate a card payment authorization via its card payment processor (acquirer/bank).

The electronic voucher application may also use the GPS function of the user's smartphone to determine the current location of the user 4. The current location of the user 4 may be sent to the issuer 2 and used in the payment verification process. In particular, the issuer 2 may compare the current location of the user 4 with the registered address and only verify payment when the user 4 is within an acceptable range of the registered address. Alternatively, or in addition, the current location of the user 4 may be used in a general payment fraud screening program. Such a program may take into consideration: the normal location of the user 4, the specified address of the user 4, the last location of the user 4 when they purchased a voucher, the time and date, etc. For example, payment may be rejected where a user purchases a voucher whilst in Spain and then 10 minutes later attempts to purchase a voucher when located in Hong Kong.

This may therefore prevent fraudulent transactions from being performed using the user's payment card.

In this regard, the acceptable range from the registered address which is allowed by the issuer may be a significant distance. For example, so long as the user 4 is located in the same country or state as their registered address, it may be assumed that the payment is genuine. However, where the user 4 appears to be currently located in a different country to that in which the user 4 has its registered address, the issuer 2 may consider the payment to be fraudulent and decline the payment.

Alternatively, the issuer 2 may require that the user 4 is located at the registered address (or at least in close proximity to the registered address) when making a payment for an electronic voucher.

If the payment verification is unsuccessful, the user 4 will be notified that the payment has been declined and informed of the reason for the payment having been declined via the electronic voucher application. On the other hand, if the payment verification is successful, the issuer 2 issues an electronic voucher to the user 4 for the requested value and currency.

The electronic voucher may be supplied to the user 4 as a unique numeric or alphanumeric code. The code may be displayed on the screen of the smartphone within the electronic voucher application and/or sent to the user 4 in an email or an SMS text message. Preferably, the code is a 25 character alphanumeric code which is designed to prevent someone who has purchased an electronic voucher from being able to deduce another valid code. The electronic voucher may also include an indication of the voucher's currency and value. In addition, the electronic voucher may contain a record of the payment method used to purchase the electronic voucher and a record of the user's country.

On issuing the electronic voucher, the issuer 2 updates a voucher database which contains details of issued vouchers. For example, the voucher database may contain the code, value and currency of each voucher and details of the user 4 to which the electronic voucher was issued. The voucher database may also contain details regarding the redemption of vouchers. Alternatively, this information may be stored in a separate database. For example, issued electronic vouchers may be transferred from an issued voucher database to a redeemed voucher database on redemption. Primarily, the database structure must ensure that the codes of issued vouchers are unique.

The electronic voucher may only be valid for a certain time, which may be measured in minutes. If the electronic voucher is not spent within this time, the voucher will automatically expire. Subsequently, if the user 4 takes no action within a certain time period, the payment server of the issuer 2 will automatically void the card payment authorization. However, the user 4 can request another electronic voucher of the same value or lower within the time period without having to perform a new card payment authorization. On the other hand, if the user 4 requires an electronic voucher of a higher value, the issuer 2 will request a separate authorization for the top-up amount. In either event, a new electronic voucher code will be generated by the issuer 2 and displayed to the user 4 via the electronic voucher application.

Where the electronic voucher system is able to provide change for any unused portion of an electronic voucher, the user 4 need not have preselected the goods or services to be purchased. Instead, the user 4 may purchase an electronic voucher from the issuer 2 for a fixed amount which may be spent as the user desires over any period of time (subject to any expiry date of the electronic voucher).

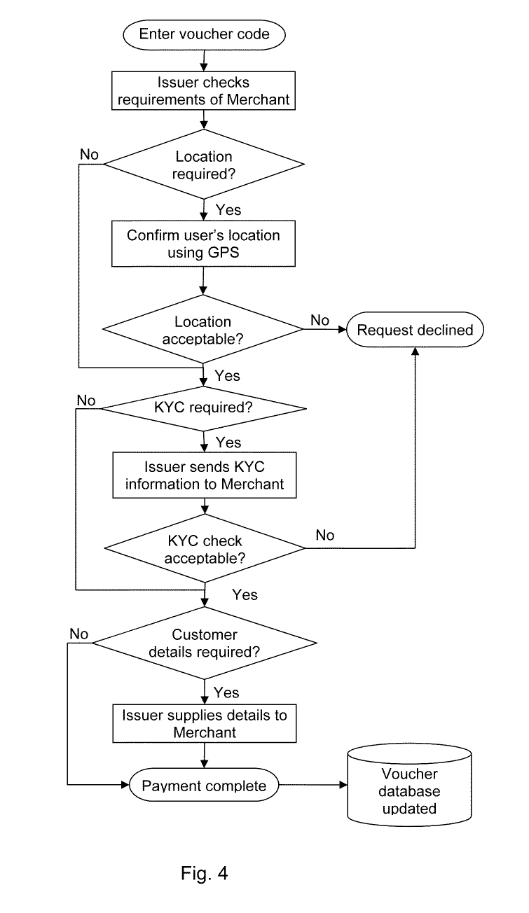

FIG. 4 is a flowchart showing a process for redeeming an electronic voucher with the merchant 6. In this respect, the user 4 is a payer and the user's smartphone functions as a payer device. Similarly, the merchant 6 is a payee and their computer systems form a payee device. Here an electronic payment is made using an electronic voucher.

As described previously, the user 4 identifies goods or services which they wish the purchase or acquire from the merchant 6. After identifying the total cost of the goods or services, the user opens the electronic voucher application on their smartphone in order to purchase an electronic voucher from the issuer 2. The merchant 6 may provide a link which opens the electronic voucher application when the user 4 wishes to pay using an electronic voucher.

Once the user 4 has purchased an appropriate electronic voucher from the issuer 2 using the electronic voucher application, the user 4 returns to the payment interface of the merchant 6 and inputs the electronic voucher code (and any other required information). Alternatively, the electronic voucher application may input such details automatically after purchase of the voucher.

The user 4 then confirms the payment with the merchant 6, at which point the merchant 6 and issuer 2 perform a payment verification.

Primarily, the payment verification involves the merchant 6 confirming with the issuer 2 that the submitted code corresponds to a voucher for the required amount and currency. Alternatively, the voucher may have been issued in a different currency to the payment being made to the merchant but, based on an appropriate exchange rate, be of sufficient value to cover the payment. This may potentially reduce foreign exchange losses on foreign merchant payments by using a beneficial Dynamic Currency Conversion at the point of sale rather than later at the card issuer end.

The issuer 2 accesses the relevant record in the voucher database and, if the submitted information matches the details of the voucher, confirms that the voucher is valid.

The payment verification also involves the transmission of information between the issuer 2 and the merchant 6 either directly or via the smartphone of the user 4.

Specifically, the issuer 2 contacts the merchant 6 to determine whether the merchant 6 requires any of the information held by, or available to, the issuer 2 in order to complete the transaction with the user 4.

As shown, the issuer 2 may first check whether the merchant 6 requires information regarding the current location of the user 4. If this is the case, the issuer 2 obtains the current location of the user 4 using the GPS function of the smartphone and transmits this information to the merchant 6. Alternatively, the merchant 6 may obtain this information directly from the smartphone of the user 4.

From the current location of the user 4, the merchant may identify an appropriate jurisdiction, such as a country or state, for the user 4. The merchant 6 may then apply the laws or other relevant rules of that jurisdiction to determine whether payment can be accepted.

For example, the merchant 6 may only be licensed to supply goods or services to users located in certain countries or states. Accordingly, it may be illegal or prohibited for the payee to supply users in other jurisdictions. In particular, the merchant 6 may be a gambling company who has a license which covers only a certain state or country.

Alternatively, the merchant 6 may be supplying goods or services which are illegal (or prohibited for other reasons) in certain states or countries. Accordingly, if the merchant 6 identifies that the user 4 is located in one of these states or countries, they may refuse to supply the user 4.

The jurisdiction of the user 4 may also be used to perform one or more data verification checks which are based on the current location of the user 4. In particular, the merchant may be supplying goods or services which are age restricted in some or all states or countries.

For example, where the user 4 is making a payment to a gambling company and the user 4 is found to be located in the US State of Nevada, the payment verification may verify whether the user 4 is over the age of 21, which is the legal gambling age in that state. A similar check may also be used where the user 4 is purchasing goods which have age restrictions in certain jurisdictions, such as cigarettes or alcohol.

The specific locations from which payments will be accepted or rejected and/or their correspondence to further location-based data checks may be determined by the merchant 6 and transmitted by the merchant 6 to the issuer 2 when a request to redeem an electronic voucher is made. Alternatively, these criteria may be held by the issuer 2 for each merchant 6 who accepts electronic vouchers issued by the issuer 2. This information may also be held in a memory of the smartphone and thus readily available to the electronic voucher application.

The locations may be defined by boundaries (based on grid positions or coordinates) which enclose an area, or simply by the names of states or countries.

During redemption of an electronic voucher, the user 4 need not be located at their registered address. As described above, the current location is used here to determine certain laws or rules which are applicable to the user 4 based on their current location.

If the user 4 does not satisfy the location-based verification check of the merchant, the request to redeem the electronic voucher is declined. However, if the user 4 passes the location-based verification check, the issuer 2 determines if any further information is required by the merchant 6.

For example, the merchant 6 may require information obtained by the issuer 2 as part of a customer verification check performed during the user registration process.

Such information may form a customer due diligence check, such as a “Know Your Customer” (KYC) check. These customer checks may be required under certain regulations. For example, some merchants are obliged to verify the identity of their customers by local regulators, specifically in the online gambling and financial services sectors, but also in environments such as telecoms where a lease agreement is involved in the overall service provision.

The merchant 6 informs the issuer 2 of the information required for the purposes of its own customer due diligence checks and the issuer 6 sends the required information to the merchant 6. Alternatively, the issuer 2 may send all of the information it holds for the user 4 (or a summary of this information) to the merchant 6 and allow the merchant 6 to identify and verify the required information. For example, the issuer 2 may send a copy of the user's identification, such as a driving license or passport, or proof of address, such as a utility bill, to the merchant 6.

Alternatively, the issuer 2 may simply confirm to the merchant 6 that the user 4 has passed the due diligence checks employed by the issuer 2. This may be appropriate where the due diligence checks performed by the issuer 2 and the merchant 6 are identical or very similar, possibly due to regulations governing such checks.

It is envisaged that the level of KYC verification held by the issuer 2 will be of suitable quality to be used by the merchant.

The current location of the user 4 provided by the GPS function of the user's smartphone may also be used to determine which customer due diligence checks are to be carried out based on the requirements for that specific country or state.

If the user 4 does not satisfy the due diligence verification check, the request to redeem the electronic voucher is declined. However, if the user 4 passes the due diligence verification check, the issuer 2 determines if any further information is required by the merchant 6.

For example, the merchant 6 may require personal details of the user 4. In particular, the merchant 6 may request information required to enable the merchant to supply goods or services to the user 4. For example, the personal details may include an address of the user 4 to which the purchased goods are to be sent. In this case, the issuer 2 sends the required personal details to the merchant 6. The personal details of the user 4 may also include their name, email address, telephone number, etc.

As the issuer 2 provides this information to the merchant 6, the user 4 is not required to manually provide these details to the merchant 6. This may provide a considerable time saving where the user 4 has dealings with a large number of merchants. Of course, the user 4 may be able to manually alter the details provided to the merchant 6, particularly where delivery is required to an alternative address.

Once the issuer 2 has checked and fulfilled all of the requirements of the merchant 6, and any verification checks have been passed by the user 4, the merchant 6 confirms to the user 4 that the electronic voucher has been accepted as payment and the transaction is complete.

The order in which the issuer 2 checks and fulfills the requirements of the merchant 6 may vary from that shown in FIG. 4. Further, if the merchant 6 does not require any such information, the payment may be accepted as soon as the issuer 2 confirms that the submitted electronic voucher is valid.

If the issuer 2 is unable to fulfill any of the requirements of the merchant 6 it will be necessary for the merchant 6 or issuer 2 to obtain this information directly from the user 4 for this purpose. For example, if the issuer 2 is not able to supply the personal details of the user 4, these may instead be manually inputted by the user 4. In contrast, if the issuer 2 cannot fulfill the due diligence verification check, the merchant 6 may decide to reject the payment and cancel the transaction with the user 4.

On completion of the transaction, the issuer 2 updates the voucher database to reflect that the electronic voucher has now been redeemed. For example, this may involve adding details regarding the redemption of the electronic voucher to the voucher database, removing the electronic voucher from the voucher database, or transferring the electronic voucher from an issued voucher database to a redeemed voucher database.

Although not shown in FIG. 4, the issuer 2 may confirm with the user 4 that they consent to the issuer 2 transmitting the requested information to the merchant 6. If the user 4 does not consent to the issuer 2 sharing this information with the merchant 6 then the transaction is terminated. This may be required to satisfy data protection regulations. Alternatively, such consent may be provided by the user 4 accepting the terms and conditions of the issuer 2 during registration and/or when purchasing an electronic voucher.

The communication between the merchant 6 and the issuer 2 may be performed via a software-to-software interface. For example, the communication may be performed via an Application Programming Interface or API. Accordingly, the communication between the merchant 6 and issuer 2 is not visible to the user 4.

Periodically the issuer 2 will make a settlement payment to the merchant 6 which reflects the total value of electronic vouchers redeemed with the merchant 6 minus any service fees charged by the issuer 2.

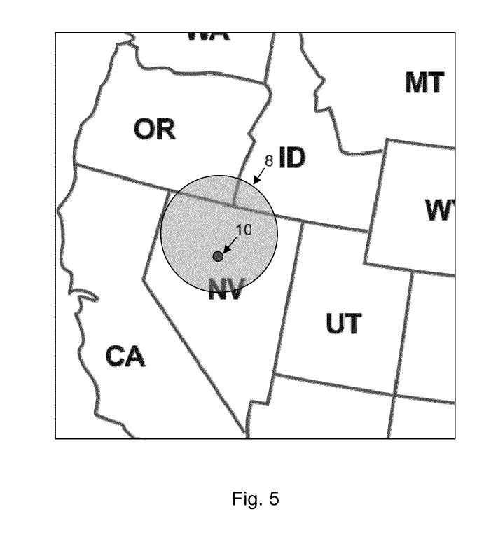

The GPS function of the user's smartphone may not be able to determine the exact location of the user 4. Specifically, the measurements made by the GPS function of the user's smartphone may have associated precision and accuracy values. FIG. 5 highlights these issues and is used to illustrate a location probability function of the electronic payment system which allows location-based verification checks to be performed even where there is uncertainty in the current location of the user 4.

As described above, the measurements made by the GPS function have associated precision and accuracy values. For example, the GPS function may have a precision of, say, ±1 meter. This produces a circular (precision) area having a radius determined by the precision of the measurement. Typically, the current location is considered as being located at the centre of this circular area. However, the accuracy of the measurements made by the GPS function may result in the centre of the circular area being offset from the actual location of the user 4. The GPS function may have an accuracy of, say, ±5 meters. As shown in FIG. 5 (although on a much larger scale for illustrative purposes), a circular (combined) area 8 may be defined based on the combined precision and accuracy values. For example, with the values given above, the combined area would have a radius of 6 meters and be centred on the centre of the precision area. Consequently, the actual location 10 of the user 4 may be reasonably expected to fall within the combined area 8.

The precision and accuracy of the measurements may vary depending on the signal strength of the smartphone.

As described above, the current location of the user 4 is used in performing various checks. For example, the current location of the user 4 may determine the state or country in which the user 4 currently resides. This may dictate the rules or laws which are applicable to the transaction and/or whether the merchant 6 is licensed or otherwise permitted to supply the user 4 in this location. It is therefore important that the exact location of the user 4 is determined.

Accordingly, the precision and/or accuracy of the GPS function may be taken into account when determining which state or country the user 4 is currently located. This may be achieved using a location probability function. The location probability function may be performed at the issuer 2 or merchant 6, or by the smartphone of the user 4.

Preferably, the location probability function uses the instantaneous or current accuracy and/or precision to account for changes in signal strength. However, the location probability function may also use indicative values for the particular smartphone being used.

As shown in FIG. 5, the combined area 8 may encompass several states or countries. Here, the combined area 8 encompasses the US States of Nevada, Oregon and Idaho. The legal gambling age in Nevada and Oregon is 21, whereas the legal gambling age in Idaho is 18. To ensure that users are over the legal gambling age, gambling companies could employ the higher of these ages. However, this would prevent users aged between 18 and 20 and residing in Idaho from gambling when they are in fact legally allowed to do so.

Further, a specific gambling company may have a license only for a specific state, such as Nevada, and thus can only allow users in that state to gamble with them.

To determine which jurisdiction applies to the user 4, the location probability function calculates a probability or likelihood of the user 4 residing in a particular country or state.

For example, the probability may be based on the proportion of the combined area 8 (or an area determined by the accuracy or precision) which falls within a specific state or country.

In the example shown in FIG. 5, the location probability function may calculate probabilities of 75% for Nevada, 10% for Idaho and 15% for Oregon.

The location probability function may then compare these probabilities with a predetermined threshold value and determine if one of the determined probabilities exceeds this threshold value. Where a probability exceeds the threshold value, the issuer 2 and/or merchant 6 is sufficiently confident that the user 4 resides in that location and thus performs location-based verification checks on that basis.

The predetermined threshold value is preferably over 50% so that only one location can exceed this value. Alternatively, if the threshold value is set at a value which is lower than 50%, the final determination may be based on the highest probability value.

For example, the threshold value may be set at 70%. Consequently, in the example shown in FIG. 5, the location probability function may conclude that the probability for Nevada exceeds this threshold and thus the issuer 2 and/or merchant 6 may perform location-based verification checks on that basis

The electronic voucher application may also have a function whereby photographs taken using a camera of the user's smartphone are uploaded to the electronic voucher application and/or transmitted to the issuer 2.

The electronic voucher system allows users to shop (including paying for services) online without ever disclosing their bank or payment card details to merchants. By not sharing these details, users are far less likely to fall victim to fraud. In addition, the electronic voucher system may employ location-based verification checks during registration and when purchasing and redeeming electronic vouchers to prevent fraudulent activity.

The use of electronic vouchers also allows users to protect their privacy by shielding their spending habits from banks and card issuers.

The transmission of information between the issuer 2 and the merchant 6 enables users to shop online faster by reducing the amount of information which they are required to provide to each merchant.

The electronic voucher system is also beneficial to merchants since they are able to accept customer payments without the risk of card fraud. It also removes the requirement for merchants to comply with the Payment Card Industry Data Security Standard (“PCI DSS”).

The electronic voucher system also ensures that merchants to do not inadvertently supply prohibited users. For example, users who are not legally permitted to purchase specific goods or services or users who the merchant is not licensed or otherwise permitted to supply.

Moreover merchants are able to capture customer details (such as delivery or billing address) from a trusted third party without asking the customer to manually enter these details. Further, the merchant can instantly verify the identity of the user.

Although the electronic voucher application has been described as operating on a smartphone, it may also be used with a tablet computer or other suitable device which has appropriate functionality (such as GPS).

Further, the invention may be extended to other forms of electronic payment. For example, the location-based verification checks may be beneficial in a direct transaction between a user and merchant, where payment is made using a conventional payment method, such as using a payment card. Similarly, when a user is carrying out a transaction with a merchant, information may be supplied to the merchant from an electronic payment issuer, such as a payment card issuer.

1. An electronic payment system comprising:
a payer device configured to perform an electronic payment process in which an electronic payment is executed, the payer device comprising positioning means which is configured to determine the current location of the payer device;
a payee device configured to receive said electronic payment; and
payment verification means which is configured to perform a location-based verification check;
wherein the payer device transmits its current location to the payment verification means during the electronic payment process and the payment verification means accepts or rejects the electronic payment based on the current location of the payer device.

2. The electronic payment system as claimed in claim 1, wherein the payee device is a device of an electronic voucher issuer.

3. The electronic payment system as claimed in claim 1, wherein the payee device is a device of a merchant.

4. The electronic payment system as claimed in claim 3, wherein the electronic payment is an electronic voucher.

5. The electronic payment system as claimed in claim 3, wherein the payer device is a device of a customer of the merchant and the electronic payment is used as payment for goods or services.

6. The electronic payment system as claimed in claim 1, wherein the positioning means of the payer device comprises a global positioning system.

7. The electronic payment system as claimed claim 1, wherein the payment verification means has access to a storage means in which there is stored a definition of one or more locations in which the electronic payment will be accepted by the location-based verification check.

8. The electronic payment system as claimed in claim 1, wherein the payment verification means has access to a storage means in which there is stored a definition of one or more locations in which the electronic payment will be rejected by the location-based verification check.

9. The electronic payment system as claimed in claim 7, wherein the one or more locations comprises one or more countries or states.

10. The electronic payment system as claimed in claim 7, wherein the one or more locations comprises a billing address of the payer.

11. The electronic payment system as claimed in claim 7, wherein the one or more locations comprises a registered location of the payer device, the registered location being provided using the positioning means of the payer device during a registration process.

12. The electronic payment system as claimed in claim 7, wherein the precision and/or accuracy of the positioning means is used by the payment verification means in determining whether the current location falls within the one or more locations stored in the storage means.

13. The electronic payment system as claimed in claim 12, wherein the payment verification means determines a probability of the current location falling within the one or more locations stored in the storage means and outputs a judgment based on whether the probability is greater than or less than a predetermined threshold value.

14. The electronic payment system as claimed in claim 1, wherein the payment verification means performs one or more data verification checks based on the current location of the payer device, and accepts or rejects the electronic payment based on the outcome of the data verification checks.

15. The electronic payment system as claimed in claim 14, wherein the data verification checks comprise an age verification check.

16. The electronic payment system as claimed in claim 1, wherein the payer device, the payee device or a third party device comprises the payment verification means.

17. A payer device, payee device or electronic voucher for use with the electronic payment system as claimed in claim 1.

18. An electronic payment method comprising:
transmitting an electronic payment using a payer device, the payer device having positioning means which is configured to determine the current location of the payer device;
receiving the electronic payment using a payee device;
determining the current location of the payer device using the positioning means and transmitting the current location of the payer device to a payment verification means;
performing at the payment verification means a location-based verification check in which the electronic payment is accepted or rejected based on the current location of the payer device.

19. The electronic payment method as claimed in claim 18, wherein the payee device is a device of an electronic voucher issuer.

20. The electronic payment method as claimed in claim 18, wherein the payee device is a device of a merchant.

21. The electronic payment method as claimed in claim 20, wherein the electronic payment is an electronic voucher.

22. The electronic payment method as claimed in claim 20, wherein the payer device is a device of a customer of the merchant and the electronic payment is used as payment for goods or services.

23. The electronic payment method as claimed in claim 18, wherein the location-based verification check comprises determining whether the current location corresponds to one or more defined locations in which the electronic payment will be accepted.

24. The electronic payment method as claimed in claim 18, wherein the location-based verification check comprises determining whether the current location corresponds to one or more defined locations in which the electronic payment will be rejected.

25. The electronic payment method as claimed in claim 24, wherein the one or more locations comprises one or more countries or states.

26. The electronic payment method as claimed in claim 24, wherein the one or more locations comprises a billing address of the payer.

27. The electronic payment method as claimed in claim 24, wherein the one or more locations comprises a registered location of the payer device, the registered location being provided using the positioning means of the payer device during a registration process.

28. The electronic payment method as claimed in claim 23, wherein the precision and/or accuracy of the positioning means is used in determining whether the current location corresponds to the one or more locations.

29. The electronic payment method as claimed in claim 28, wherein the location-based verification check further comprises determining a probability of the current location falling within the one or more locations; comparing the probability with a predetermined threshold value; and outputting a judgment based on whether the probability is greater than or less than the predetermined threshold value.

30. The electronic payment method as claimed in claim 19, wherein the location-based verification check comprises performing one or more data verification checks based on the current location of the payer device, and accepting or rejecting the electronic payment based on the outcome of the data verification checks.

31. The electronic payment method as claimed in claim 30, wherein performing one or more data verification checks comprises performing an age verification check.

32. The electronic payment method as claimed in claim 18, wherein the payer device, the payee device or a third party device comprises the payment verification means.

33. A device which executes the electronic payment method as claimed in claim 18.

34. A program which when run on a device causes the device to perform an electronic payment method as claimed in claim 18.

35. A smartphone application comprising a program as claimed in claim 34.

36. An electronic voucher for use in the electronic payment method as claimed in claim 18.

37. An electronic payment method comprising:
a payer making an electronic payment with a merchant, the electronic payment being issued by an electronic payment issuer;
the merchant requesting information regarding the payer from the issuer; and
the issuer obtaining the requested information from a database containing information provided by the payer during a payer registration process with the issuer and transmitting the requested information to the merchant.

38. The electronic payment method as claimed in claim 37, wherein the electronic payment is an electronic voucher.

39. The electronic payment method as claimed in claim 37, wherein the requested information comprises personal details of the payer.

40. The electronic payment method as claimed in claim 39, wherein the personal details of the payer comprises information required to enable the merchant to supply goods or services to the payer.

41. The electronic payment method as claimed in claim 37, wherein the requested information comprises information obtained during a customer verification check performed by the issuer during the payer registration process.

42. The electronic payment method as claimed in claim 37, wherein the requested information is a result of a customer verification check performed by the issuer during the payer registration process.

43. The electronic payment method as claimed in claim 37, further comprising confirming with the payer that they consent to the issuer transmitting the requested information to the merchant.

44. The electronic payment method as claimed in claim 37, wherein the requested information is transmitted from the issuer to the merchant via a software-to-software interface.

45. The electronic payment method as claimed in claim 37, wherein the request from the merchant to the issuer is transmitted from the merchant to the issuer via a software-to-software interface.

46. An electronic voucher for use in the electronic payment method as claimed in claim 37.
